(19) United States
(12) Patent Application Publication
(10) Pub. No.: US 2016/0147823 A1
(43) Pub. Date: May 26, 2016

(54) PATTERN-BASED PROBLEM DETERMINATION GUIDANCE

(71) Applicant: International Business Machines Corporation, Armonk, NY (US)

(72) Inventors: Dietmar Noll, Bad Soden-Salm (DE); Oliver Roehrsheim, Partenheim (DE); Horst Zisgen, Nierstein (DE)

(21) Appl. No.: 14/843,037

(22) Filed: Sep. 2, 2015

Related U.S. Application Data
(63) Continuation of application No. 14/551,163, filed on Nov. 24, 2014.

(51) Int. Cl. G06F 17/30

(52) U.S. Cl. CPC G06F 17/30371; G06F 17/30336

(57) ABSTRACT

Embodiments in accordance with the present invention disclose a method and system for pattern-based problem determination guidance. The method involves receiving data with respect to a computer system and determining a pattern index based on the data, searching a database to find a matching pattern index, creating problem determination guidance based on the matching pattern index and an associated PCI triplet, sending the guidance to the computer system and receiving feedback from the computer system indicating the corrective action that was implemented, along with a response of the computer system, and storing in the database, data indicating the corrective action, and the response of the computer system to the corrective action.

### BACKGROUND OF THE INVENTION

The present disclosure relates generally to storage management systems, and more specifically to a method and system for an optimized determination of root cause of a failure or performance degradation in a heterogeneous system infrastructure.

Managing a large, heterogeneous storage area network (SAN) environment is becoming increasingly complex as time evolves. As businesses become more instrumented, interconnected, and intelligent, the amount of data exchanged between the involved systems and the volume of available data about their configuration, performance, and operational state is huge. Filtering out unimportant data, and efficiently analyzing important data are desired operating aspects of a data center.

Problem determination, sometimes referred to as failure analysis, is one of many system management activities heavily impacted by the complexity of storage environments amid increasing levels of virtualization and emerging technologies. Finding a root cause of a problem, such as a performance degradation, that has a negative impact on the managed environment, such as a SAN infrastructure, often involves analysis of large amounts of data, including performance, topology, and configuration data. It is desirable to determine the root cause of the problem and potential impact and risk as soon as possible to avoid or minimize impacts on SAN infrastructure operations.

Because it is not practical, and often not necessary, for system administrators to analyze all available data, automated system support is typically provided, which can transform the data into useful information helping administrators to make appropriate and timely decisions. Such support systems are termed storage resource management (SRM) systems.

With available SRM systems, data can be collected and made available to system administrators who monitor the health status of the monitored SAN infrastructure. “Health” refers to many types of data and metrics which should be within appropriate ranges, or at appropriate states, for the data center to perform at acceptable levels. Examples of such data and metrics include device states, performance data, application activity, storage capacity utilization, etc. The data can be presented to administrators in various forms, including charts and graphs. Analyzing the data requires manual effort in conjunction with a great deal of knowledge, and a focus on relevant data, to avoid wasting time and effort examining irrelevant data. It is often desirable for the system administrator to have an in-depth knowledge of the configuration of the SAN infrastructure, the interdependence and interrelationships of components comprising the SAN infrastructure, and the associated data and metrics, to identify potential risks and intervene when necessary to avoid adverse impact from a developing situation, or quickly to recover from a disruption.

### SUMMARY

Embodiments in accordance with the present invention disclose a method and system for pattern-based problem determination guidance. The method comprises: receiving current data with respect to the computer system, the current data comprising one or more of infrastructure data, performance data and user activity data; determining a current pattern index based, at least in part, on the current data; searching a database to find a historical pattern index that matches the current pattern index; determining problem determination guidance based at least in part on the matching historical pattern index and a historical PCI triplet (pattern index/corrective action/impact factor triplet) associated with the matching historical pattern index; sending the problem determination guidance to the computer system; receiving data indicating at least a new corrective action, and a response of the computer system to the new corrective action; creating a new PCI triplet based at least in part on the current pattern index, a current corrective action, and the response of the computer system to the current corrective action; and storing in the database, data indicating the corrective action, and the response of the computer system to the corrective action.

### BRIEF DESCRIPTION OF THE DRAWINGS

FIG. 1 is a functional block diagram illustrating a storage area network (SAN) system environment, in accordance with an embodiment of the present invention;

FIG. 2 is a flowchart describing an overview of operational steps to develop recommendations for failure analysis of a SAN infrastructure failure, in accordance with an embodiment of the present invention; and

FIG. 3 depicts a block diagram of internal and external components of a computer system, such as computer system 102, in accordance with an embodiment of the present invention.

### DETAILED DESCRIPTION

Disclosed herein is a system and method for optimizing root cause analysis of a failure or performance degradation, in a heterogeneous system infrastructure, wherein the heterogeneous system infrastructure comprises at least two system components interacting with each other and at least a system management system, which provides support for analyzing data characterizing a system configuration, infrastructure, and traces of user activities.

The disclosed system and method support the storage administrator (also referred to as administrator, or system administrator) in analyzing vast amounts of data, in particular by guiding the administrator to the system component and metric data most likely to be relevant to the current problem. Such guidance is based at least in part on pattern-based problem determination, to help identify the root cause of a failure or performance degradation, and to identify appropriate corrective actions based on the recorded experiences of a variety of administrators operating a variety of systems. Moreover, guidance provided by embodiments in accordance with the present invention indicates certain system components and metric data as being irrelevant, thereby helping system administrators to avoid wasting time and effort analyzing data irrelevant to the current problem.

Guidance, provided by embodiments in accordance with the present invention, is based, at least in part, on recognizing patterns in the data and comparing them with patterns which have been recognized in previous analyses as leading to a successful root cause identification.

Patterns associated with previous analyses need not originate from one SRM system or organization, but are capable of being maintained in an external database, wherein analysis patterns from a large number of contributing systems can be collected and evaluated, leading to a growing pattern repository of increasing value for users of such systems.

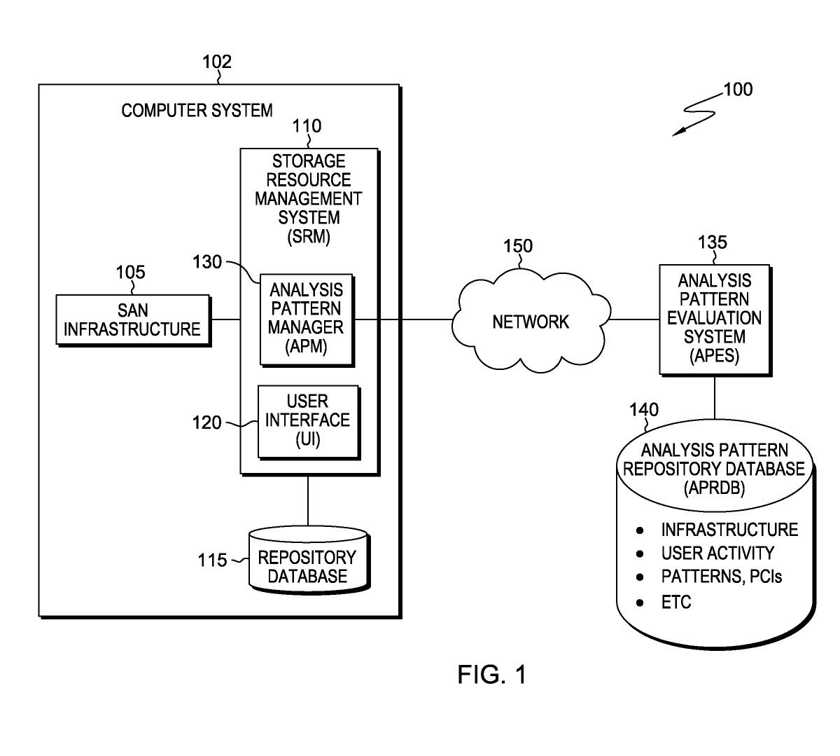

FIG. 1 is a functional block diagram illustrating a storage area network (SAN) system environment, generally designated 100, in accordance with an embodiment of the present invention.

SAN system environment 100 comprises computer system 102, network 150, analysis pattern evaluation system (APES) 135, and analysis pattern repository database (APRDB) 140. In this illustrative embodiment, APES 135 and APRDB 140 are stored remotely, and may be accessed via a network, such as network 150.

Computer system 102 comprises SAN infrastructure 105, storage resource management system (SRM) 110, and repository database 115. SAN infrastructure 105 may include a dedicated network that provides access to consolidated, block level data storage, used primarily to augment storage devices, such as disk arrays, tape libraries, and optical jukeboxes, wherein the devices appear to the operating system as locally attached devices. SAN infrastructure 105 may also include one or more fiber channel switches, and a fiber channel fabric topology, to reliably handle storage communications, data switches, and block storage devices.

SRM 110 comprises analysis pattern manager (APM) 130, and at least one user interface (UI) 120. UI 120 may be, for example, a graphical user interface (GUI) or a web user interface (WUI) and can display text, documents, web browser windows, user options, application interfaces, and instructions for operation and includes the information (e.g., graphic, text, and sound) a program presents to a user and the control sequences the user employs to control the program.

Functions performed by APM 130, in some embodiments in accordance with the present invention, include communicating with APES 135 via network 150; monitoring user interactions; interfacing with APES 135 via network 150; collecting user activity traces and data pertaining to the configuration, performance, and system events (e.g., failure or imminent failure of a storage device) of SAN infrastructure 105; recording actions taken by users and administrators; transmitting recorded data to APES 135; receiving from APES 135 a recommended approach for root cause analysis of a SAN infrastructure 105 problem; interfacing with UI 120 to present the recommendations for failure analysis to system administrators or other users; collecting data pertaining to actions taken by administrators or other users and the impact of the actions taken with respect to solving the SAN infrastructure 105 problem; and transmitting the data pertaining to the impact of actions taken by administrators or other users, to APES 135.

Repository database 115 comprises a data store wherein system and infrastructure data relevant to SAN infrastructure 105 is stored and accessible to APM 130 and SRM 110.

Network 150 can be, for example, a local area network (LAN), a wide area network (WAN) such as the Internet, or a combination of the two, and can include wired, wireless, or fiber optic connections. In general, network 150 can be any combination of connections and protocols that will support communication between computer system 102 and APES 135.

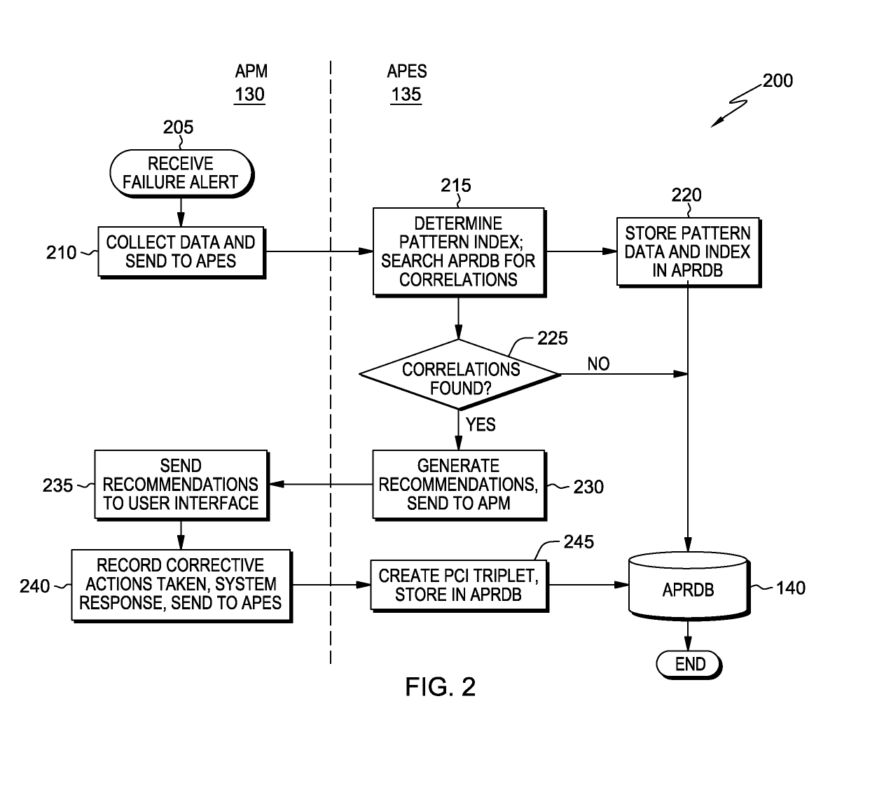

Functions performed by APES 135, in some embodiments in accordance with the present invention, include: receiving data from APM 130 and storing the data in APRDB 140; determining a current pattern index based, at least in part, on data pertaining to a SAN infrastructure 105 problem; comparing a current pattern index to historical pattern indexes stored in APRDB 140 to identify historical pattern indexes that match the current pattern within pre-defined threshold parameters, using pre-defined matching criteria; determining based, at least in part, on data stored in APRDB 140 and the aforementioned pattern index matching, a recommended analysis approach for identifying a root cause of the current SAN infrastructure 105 problem resolution; and returning the recommended analysis approach for a root cause resolution to APM 130. A more detailed discussion of APES 135 functionality is found below with respect to FIG. 2.

Functions performed by APRDB 140, in some embodiments in accordance with the present invention include: Interfacing with APES 135 whereby APES 135 can store and retrieve data from APRDB 140; maintaining a repository of data including SAN infrastructure 105 data, such as user activity traces, patterns, one or more time stamps, monitored time periods, infrastructure changes that take place during a monitored time period; current and historical pattern indexes, and performance data such as transmission rates between components within SAN infrastructure 105, and read/write operations at the hard drive disk level. Moreover, data stored in APRDB 140 can include data gathered from SAN infrastructure 105, as well as similar data gathered from other systems, not shown.

FIG. 2 is a flowchart describing operational steps and interactions performed by APM 130 and APES 135 to develop recommendations for failure analysis of a SAN infrastructure 105 failure, in embodiments in accordance with the present invention. In step 205, AMP 130 receives a system failure alert, which can be triggered by various system events or conditions affecting performance of SAN infrastructure 105, such as a general performance degradation, a bandwidth bottleneck, etc. A failure alert can also be triggered by an indication of an imminent failure of a component of SAN infrastructure 105. A situation that triggers the system failure alert is referred to herein as the “current problem.” Responsive to receipt of the failure alert, APM 130 retrieves current pattern data from repository database 115, and sends the current pattern data to APES 135 (function block 210). Current pattern data comprises one or more predefined data structures for at least infrastructure and component performance data, as well as user traces. Furthermore, pattern data can comprise non-structured data as implemented in some embodiments in accordance with the present invention.

Responsive to receiving the current pattern data, APES 135 determines a current pattern index, based at least in part on the current pattern data (function block 215) and searches APRDB 140 to identify one or more historical pattern indexes in APRDB 140 that match sufficiently closely, the current pattern index (function block 215). The pattern data and pattern index are stored in APRDB 140 (function block 220). “Matching sufficiently closely” is sometimes referred to as a degree of correlation.

A more detailed discussion regarding the pattern index, and a method of searching for a correlation between the current pattern index and a historical pattern index, is provided below, following this overview discussion of FIG. 2.

If APES 135 fails to find a sufficiently close match between the current pattern index and historical pattern indexes (decision block 225, “No” branch), APES 135 stores the current pattern index and associated data in APRDB 140. The quantitative meaning of a “sufficiently close” match between the current pattern index and a historical pattern index is an aspect of embodiments in accordance with the present invention, and may involve establishment of one or more comparison criteria or threshold parameters, and may involve one or more analysis techniques, such as statistical, heuristics or other techniques in any combination, against which a prospective match is evaluated.

If APES 135 finds a historical pattern index that matches the current pattern index (i.e., APES 135 finds a sufficiently strong correlation between the current pattern index and one or more historical pattern indexes) (decision block 225, “Yes” branch), it generates a prioritized list comprising one or more recommendations, to provide guidance to system administrators and to aid them in diagnosing and resolving the current problem. The prioritized list of one or more recommendations comprises at least data, from the corrective actions fields of the one or more matching historical pattern indexes, particularly from the one or more matching historical pattern indexes that are associated with PCI triplets having the highest impact factors. Discussion of a PCI triplet is provided below with reference to function block 245. APES 135 sends the recommendations to APM 130 (function block 230) whereupon the recommendations are routed to UI 120 (function block 235).

System administrators diagnose the current problem, with reference to at least the recommendations, to decide what corrective actions are to be taken. APM 130 records the corrective actions taken and records changes in SAN infrastructure 105 performance in response to implementation of the corrective actions, by recording new performance data for the same parameters as were included in the performance data block of the current pattern. APM 130 sends at least the corrective actions taken, including system configuration changes, and the resultant system performance response, to APES 135 (function block 240).

Responsive to receiving the corrective actions and resultant system response, APES 135 determines an impact factor. An impact factor is a measure or notation of the effectiveness of the corrective action in alleviating the current problem. A method for creating an impact factor in an embodiment in accordance with the present invention, is presented below, relative to an algorithm for creating a PCI triplet.

APES 135 combines the current pattern index, corrective actions taken, and impact factor into a data structure referred to as a PCI triplet (Pattern/Corrective Action/Impact Factor triplet) and stores the PCI triplet in APRDB 140 (function block 245), adding to the store of knowledge housed therein.

The present discussion now turns to providing additional details with respect to creation of the pattern index in some embodiments in accordance with the present invention.

A pattern index is based, at least in part, on pattern data, the pattern data comprising, for example, three types of information: Data to specify the setup of the systems infrastructure and to identify the elements of the infrastructure; performance data measured a certain period of time before and after the onset of a performance degradation or failure (referred to as the current problem); and user activity traces logged a certain period of time before and after the onset of the current problem, e.g., adding volumes, changes in network routing, deleting volumes, etc.

A pattern index is a vector or data structure comprising three sub-vectors: sub-vector1, sub-vector2, and sub-vector3, the sub-vectors representing infrastructure data, performance data and user scenarios respectively. To determine a pattern index, the following algorithm can be used in some embodiments in accordance with the present invention:

1) Sub-vector1 is determined. Sub-vector1 comprises a numerical value or other indicator to represent the complexity level of each infrastructure component. A complexity level is assigned to each component type and the results inserted into sub-vector1. Complexity level (for example, low, medium or high) is based on pre-defined criteria. For example, a SAN infrastructure 105 comprising fewer than five (5) servers might be defined as having low complexity with regard to servers whereas ten (10) or more servers might define SAN infrastructure 105 as having high server complexity. Other infrastructure component types, such as switches, block storage devices etc., each have their respective complexity definitions. Complexity level is based, for example, on the number of instances of the component type included in the system, or on other criteria as might be implemented in an embodiment in accordance with the present invention.

2) Sub-vector2 is determined. Sub-vector2 comprises a “relative distance” value for each performance data point. A relative distance is computed for each system infrastructure component and the results inserted into sub-vector2. Relative distance is a measure of a component's performance relative to its nominal performance range and is computed as the ratio of (i) the difference between the measured data point and the mean of the nominal range for the performance data, divided by (ii) the width of the nominal range. A relative distance having an absolute value less than 0.5 thus represents a data point that is within the nominal range, and greater than 0.5 represents a data point that is outside the nominal range. A nominal range for the performance of each component can be determined by a combination of experience, and comparison with other infrastructure and performance data, or by derivation from models of SAN infrastructure 105.

3) Sub-vector3 is determined. Sub-vector3 comprises a pre-defined alphanumerical value to represent an underlying user scenarios based at least in part on a sequence of user actions, and is inserted into sub-vector3. An underlying user scenario can be determined by dividing user activity traces into blocks of interrelated actions and assigning each block to a user activity category such as “add a volume,” “delete a volume,” “increase a volume size,” etc. The resulting value or values are inserted into sub-vector3.

4) Create the pattern index. The three sub-vectors are combined into a pattern index data structure.

It is noted here that in some embodiments in accordance with the present invention pattern data can include types of information in addition to, or instead of, infrastructure, performance and user action data as presented in this discussion. Moreover, a pattern index may comprise more, fewer, or different sub-vectors, in any combination, than are illustrated in this disclosure.

It is noted here that in some embodiments in accordance with the present invention, pattern data, and the respective pattern index, can include types of information in addition to, or instead of, infrastructure, performance and user action data as presented in this discussion.

The following discussion presents the creation of a pattern index in an embodiment in accordance with the present invention, based on hypothetical pattern data for illustrative purposes.

Sub-Vector1—Infrastructure Data:

Number of servers: 2. Complexity: Low. Sub-vector1 first element: (0).

Number of block storage devices: 2. Complexity: Medium. Sub-vector1 second element: (1).

Number of NAS (network attached storage) storage devices: 1. Complexity: Low. Sub-vector1 third element: (0).

Number of switches: 1. Complexity: Low. Sub-vector1 fourth element: (0).

Based on the foregoing infrastructure data block values, sub-vector1 is (0, 1, 0, 0).

Sub-Vector 2—Performance Data:

CPU (central processing unit) utilization per server:

CPU1 utilization: 63%. Nominal range: 30% to 60%. Mean of nominal range=(30%+60%)/2=45%. Difference between the data point and mean of nominal range=63% −45%=18%. Width of nominal range=60%−30%=30%. Relative distance=18%/30%=0.600. Sub-vector2 first element: (0.600).

CPU2 utilization: 41%. Nominal range: 20% to 80%. Mean of nominal range=(20%+80%)/2=50%. Difference between the data point and mean of nominal range=41% −50%=−9%. Width of nominal range=80%−20%=60%. Relative distance=−9%/60%=−0.150. (Sub-vector2 second element: (−0.150).

Relative distance for the remaining performance data points is calculated in a manner similar to the foregoing CPU utilization examples with the following results:

I/O rate per block storage (BSn):

BS1 I/O rate: 670 iops (input/output operations per second). Nominal range: 10 to 1000 iops. Sub-vector2 third element: (0.167).

BS2 I/O rate: 455 iops. Nominal range: 10 to 500 iops. Sub-vector2 fourth element: (0.408).

Throughput per NAS device:

NAS1 throughput: 18 Gb/s. Nominal range: 1 to 18 Gb/s. Sub-vector2 fifth element: (0.500)

Throughput per switch:

Switch 1 throughput: 117 Gb/s. Nominal range: 2 to 150 Gb/s. Sub-vector2 sixth element: (0.277).

Based on the foregoing performance data block values, sub-vector2 is (0.600, −0.150, 0.167, 0.408, 0.500, 0.277).

Sub-Vector 3—User Activity:

Activities: “Increase volume”; “Assign new server”. User scenario: Increase storage capacity. Sub-vector3 first element: (A) (determined by lookup in a pre-defined table, not shown, of user scenarios).

Assemble the Pattern Index:

Assemble sub-vector1, sub-vector2, and sub-vector3 into the pattern index: [(0,0,1,0); (0.600, −0.150, 0.167, 0.408, 0.500, 0.277); (A)]

Algorithm for creating a PCI triplet in embodiments in accordance with the present invention is now given.

Creation of a PCI triplet follows the actions summarized here: Initially based at least in part on a pattern derived from system data, guidance for failure analysis is determined and made available to system administrators. System administrators determine corrective action steps to take, based at least in part on the guidance received. The computer system responds to the corrective action steps implemented by system administrators. Data, representing at least the corrective action steps implemented, and the computer system response thereto, is received by APES 135. APES 135 determines an impact factor based at least in part on the data received. An impact factor is a measure of the effectiveness of the corrective action. An impact factor can be for example: “Positive” (the corrective action was effective in resolving the current problem and did not adversely impact operating performance of other system components); “Neutral” (the corrective action had little or no impact with regard to the current problem); or “Negative” (the corrective action worsened the current problem or adversely affected operating performance of other system components). Other systems to classify or measure impact factor can be implemented in embodiments in accordance with the present invention.

Three elements, pattern index, corrective action and impact factor, are combined into an element referred to as a “Pattern/Corrective Action/Impact Factor” (PCI) triplet, as follows:

Case A, triggered by a request for a corrective action:

A-1) Load the pattern index associated with the problem for which the corrective action is requested, and assign the pattern index as the first element of the PCI.

A-2) Load the proposed corrective action (which is a sequence of actions such as the user activity block of the pattern) and assign the proposed corrective action as the second element of the PCI.

A-3) Monitor, via at least APM 130, the effectiveness of the corrective action.

A-4) For the performance data given in the performance data block of the pattern, measure the new values.

A-5) For each element of the performance data block, compare the corresponding performance values measured before and after execution of the corrective action.

A-6) Determine an impact factor and assign it as the third element of the PCI:

A-6a) If the performance values which have been out of nominal range before execution of the corrective action are within nominal range after execution of the corrective action and if other performance values have not worsened (i.e. have no greater relative distance) then assign an impact factor “Very Positive”.

A-6b) If the performance values which have been out of nominal range before execution of the corrective action have a lower relative distance but still out of range after execution of the corrective action, and if other performance values have not worsened, then assign an impact factor “Positive”.

A-6c) If the performance values which have been out of nominal range before execution of the corrective action remain out of range after execution of the corrective action, and if other performance values have not worsened, then assign an impact factor “None”.

A-6d) If the performance values which have been out of nominal range before execution of the corrective action remain out of range after execution of the corrective action and if others have worsened, then assign an impact factor “Worse”.

Case B, triggered by system monitoring to train the system:

B-1) Create a pattern index for the current infrastructure setup and assign the pattern index as the first element of the PCI.

B-2) Monitor user activity via APM 130 and create user activity steps (similar to the corrective action steps discussed above with respect to Case A.) and assign this to the corrective action element of the PCI triplet

B-3) For the performance data given in the performance data block of the pattern, measure new values (after the user activities have been performed)

B-4) For each element of the performance data block, compare the corresponding performance values measured before and after execution of the corrective action.

B-5). Determine the impact factor and assign it as the third element of the PCI:

B-5a) If the performance values which have been out of nominal range before execution of the corrective action are within nominal range after execution of the corrective action and if other performance values have not worsened (i.e., have no greater relative distance) then assign an impact factor “Very Positive”.

B-5b) If the performance values which have been out of nominal range before execution of the corrective action have a lower relative distance but still out of range after execution of the corrective action, and if other performance values have not worsened, then assign an impact factor “Positive”.

B-5c) If the performance values which have been out of nominal range before execution of the corrective action remain out of range after execution of the corrective action, and if other performance values have not worsened, then assign an impact factor “None”.

B-5d) If the performance values which have been out of nominal range before execution of the corrective action remain out of range after execution of the corrective action and if others have worsened, then assign an impact factor “Worse”.

Pattern matching is the process of comparing the pattern corresponding to the current problem (the current pattern corresponding to the current problem) against the patterns stored in APRDB 140 (historical patterns). In some embodiments in accordance with the present invention, pattern matching can be conducted using the following algorithm:

1) Check first for a comparable set of information, and filter out historical patterns having significantly more or significantly fewer parameters than the current pattern. As used elsewhere in these examples, the quantitative meaning of “significantly” is an implementation aspect of embodiments in accordance with the present invention.

2) For the remaining patterns (historical patterns not filtered out in step 1 above), compare the infrastructure complexities of the current pattern and the remaining historical patterns, and filter out historical patterns having a different level of complexity. One way to compare complexities is to accept only patterns where the infrastructure complexity levels of the historical and current patterns differ by no more than one level. For example, when comparing two patterns having complexity sub-vectors (0,1,2,1) and (1,0,1,1) respectively, the historical pattern would be accepted if accepting a complexity difference of 1 for each element but the historical pattern would be filtered out as having different complexities if accepting no difference.

3) For remaining patterns (historical patterns not filtered out in prior steps above) compare the performance situations of the current pattern with those of the historical patterns, and reject historical patterns having performance situations that differ significantly from the corresponding performance situations of the current pattern.

4) For remaining patterns (historical patterns not filtered out in prior steps above) check for similar user activity, for example by defining user activity similarity by a neighborhood matrix or other comparison technique.

5) From the remaining patterns (historical patterns not filtered out in prior steps above) choose n historical patterns which most closely match the current pattern, where n is an aspect of implementations in embodiments in accordance with the present invention.

6) From the remaining historical patterns (historical patterns not filtered out in prior steps above), filter out the historical patterns for which the PCIs associated with those historical patterns indicate a poor system response to the associated corrective actions.

7) From the remaining historical patterns (historical patterns not filtered out in prior steps above), select one or more PCIs associated with the remaining historical patterns, selecting PCIs which have the most favorable impact factors, and extract the corrective actions from the corrective actions field of the selected PCIs. Send the corrective actions to system administrators, the corrective actions serving as guidance to help diagnose and resolve the current problem.

An example is now presented, to illustrate the foregoing pattern matching algorithm in some embodiments in accordance with the present invention.

A current pattern index (p0) is specified as follows and represents data associated with a current problem in need of resolution.

p0: [(0,0,1,0); (0.600, −0.150, 0.167, 0.408, 0.500, 0.277); (A)]

Historical pattern indexes p1 through p5 are available in APRDB 140:

p1: [(0, 0, 1, 0); (2, 1, 0.5, 3, 9, 2); (B)]

p2: [(0, 0, 1, 0); (0.5, 0.037, 0.3, 0.4, 0.4, 0.6); (A)]

p3: [(2, 0, 1, 2); (43, −9, 165, 200, 9, 35); (A)]

p4: [(0, 0, 1, 0); (45, −6, 165, 18, 9, 35); (C)]

p5: [(0, 0, 1, 0); (0.6, 0.02, 0.175, 0.38, 0.6, 0.49); (A)]

Historical PCI triplets PCI1 and PCI5, associated with p2 and p5 respectively, are available in APRDB 140:

PCI2: {[(0, 0, 1, 0); (0.5, 0.037, 0.3, 0.4, 0.4, 0.6); (A)], Deleted volume, Worse}

PCI5: {[(0, 0, 1, 0); (0.6, 0.02, 0.175, 0.38, 0.6, 0.49); (A)], Added volume, Very positive}

The pattern index matching algorithm described above is conducted as follows in some embodiments in accordance with the present invention:

1) Pattern indexes p1 through p5 represent information comparable to pattern index p0. Therefore none are filtered out.

2) Pattern index p3 has infrastructure data (2, 0, 1, 2) representing significantly different complexity levels from the infrastructure data in p0 (0, 0, 1, 0). Therefore, p3 is filtered out.

3) Performance values (2, 1, 0.5, 3, 9, 2) in pattern index p1 are significantly different from the performance values (0.600, −0.150, 0.167, 0.408, 0.500, 0.277) in pattern index p0, (5 of 6 components are outside nominal performance ranges in p1, whereas only 1 component is outside nominal performance range in p0). Moreover, user activity (B) in p1 differs from user activity (A) of p0. Therefore, for at least one of the foregoing reasons, p1 is filtered out.

4) User activity (C) in p4 differs from user activity (A) in p0. Therefore, p4 is filtered out.

5) Pattern indexes p2 and p5 remain as good fits with p0.

6) Examine PCI2 and PCI5, (from APRDB 140) associated with pattern indexes p2 and p5 respectively. PCI2 indicates a poor system response (Worse) to the corrective action (Deleted volume) recorded in PCI2. Therefore, p2 is filtered out. PCI5 indicates a good system response (Very positive) to the corrective action (Added volume) recorded in PCI5.

7) Pattern index p5 remains. Extract the corrective actions (Added volume) from the corrective actions field of the PCI5. The corrective actions comprise the recommendations that will be sent to system administrators as guidance for failure analysis and resolution of the current problem.

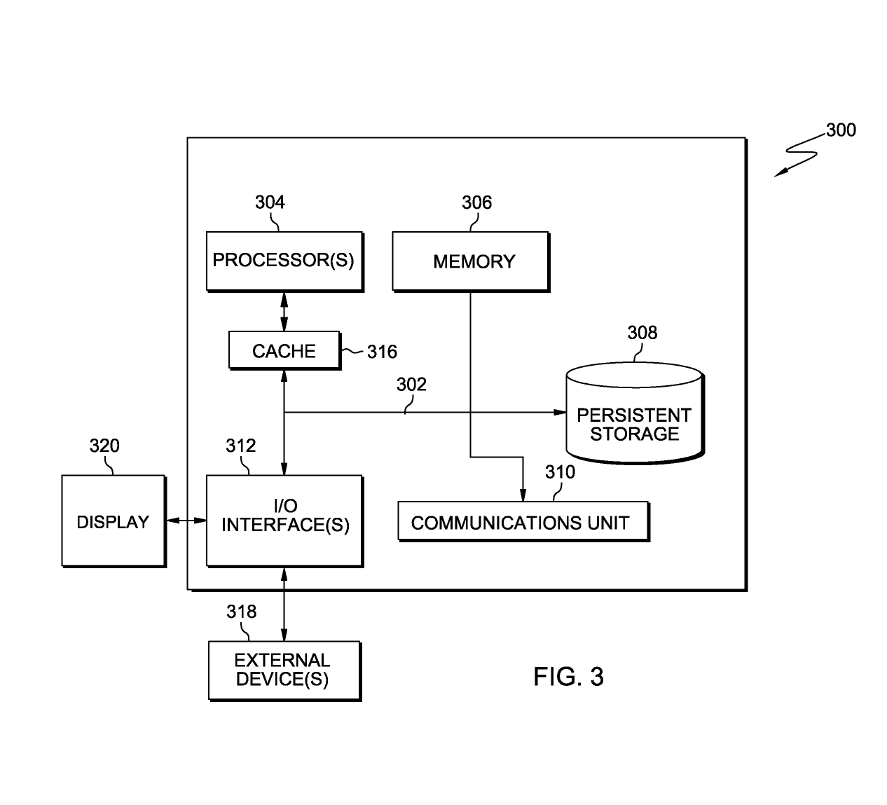

FIG. 3 depicts a block diagram of components of an illustrative computer system, generally designated with numeral 300, for implementing embodiments in accordance with the present invention. Computer system 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of processors 304 by holding recently accessed data and data near accessed data from memory 306.

Program instructions and data used to practice embodiments of the present invention may be stored in persistent storage 308 for execution by one or more of the respective processors 304 via cache 316 and one or more memories of memory 306. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Program instructions and data used to practice embodiments of the present invention may be downloaded to persistent storage 308 through communications unit 310.

I/O interface(s) 312 allows for input and output of data with other devices that may be connected to each computer system. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for pattern-based problem determination guidance, the method comprising:
receiving, by one or more processors, from a computer system, current data with respect to the computer system, the current data comprising one or more of infrastructure data, performance data, and user activity data;
determining, by one or more processors, a current pattern index based, at least in part, on the current data;
searching, by one or more processors, a database, to find a historical pattern index which matches the current pattern index, to identify a matching historical pattern index;
determining, by one or more processors, a problem determination guidance based at least in part on the matching historical pattern index and a historical PCI triplet (pattern index/corrective action/impact factor triplet) associated with the matching historical pattern index;
sending, by one or more processors, the problem determination guidance to the computer system;
receiving, by one or more processors, from the computer system, data indicating at least a new corrective action, and a response of the computer system to the new corrective action;
creating, by one or more processors, a PCI triplet based, at least in part, on the current pattern index, a current corrective action, and the response of the computer system to the current corrective action; and
storing, by one or more processors, data representing a response of the computer system to the new corrective actions taken.

2. The method of claim 1, wherein the step of determining, by the one or more processors, the current pattern index comprises:
assigning a complexity value to an infrastructure element;
determining a relative distance for an infrastructure element, the relative distance based, at least in part, on a nominal performance range for the infrastructure element and a performance value for the infrastructure element, wherein the relative distance is computed according to a pre-defined method;
determining a user scenario based, at least in part, on user activity data; and
combining the complexity value, the relative distance for the infrastructure element, and the user scenario into the current pattern index.

3. The method of claim 1, wherein the step of searching, by the one or more processors, a database, to find a historical pattern index which matches the current pattern index, to identify a matching historical pattern index comprises:
retrieving a historical pattern index from a database;
comparing the historical pattern index with the current pattern index; and
selecting a historical pattern index that matches the current pattern index, based on pre-defined matching criteria.

4. The method of claim 1, wherein the step of determining, by the one or more processors, a problem determination guidance based at least in part on the matching historical pattern index and the historical PCI triplet associated with the matching historical pattern index comprises:
retrieving from a database, the historical PCI triplet corresponding to the matching historical pattern index;
extracting from the historical PCI triplet, a historical corrective action; and
creating a problem determination guidance based, at least in part, on the historical corrective action.

5. The method of claim 1, wherein the step of storing, by the one or more processors, data representing a response of the computer system to the new corrective actions taken comprises:
determining a new PCI triplet based at least in part on the data representing a response of the computer system to the new corrective action taken; and
storing the new PCI triplet, in the database.

6. The method of claim 3 wherein the step of selecting, by the one or more processors, a historical pattern index that matches the current pattern index, based on pre-defined matching criteria comprises:
retrieving from a database, a historical PCI triplet corresponding to a matching historical pattern index;
extracting from the historical PCI triplet, an impact factor, wherein the impact factor comprises a system response to a historical problem;
responsive to the impact factor indicating a poor system response with respect to the historical problem, rejecting the matching historical pattern index and the historical PCI triplet; and
responsive to the impact factor indicating a positive system response with respect to the historical problem, selecting the matching historical pattern index and a corresponding historical PCI triplet.
